(19) United States
(12) Patent Application Publication
(10) Pub. No.: US 2003/0079614 A1
(43) Pub. Date: May 1, 2003

(54) Ergonomic stir-frying cookware

(76) Inventor: Timour T. Shu, Quinton, VA (US)

Correspondence Address: Peter K. Kontler, 4401 Gulf Shore Blvd. North, Naples, FL, 34103-3450, US

(21) Appl. No.: 10/047,955

(22) Filed: Oct. 26, 2001

(51) Int. Cl. A47J 37/10; A47J 37/12

(52) U.S. Cl. 99/422; 99/403

(57) ABSTRACT

A utensil, such as a wok, for stir-frying foodstuffs has a bowl with a substantially oval rim, an elongated handle having a non-circular cross-sectional outline, and joints for connecting the handle to the bowl in such a way that the handle is adjustable relative to the bowl about at least one of two axes one of which extends substantially radially and the other of which extends substantially tangentially of the bowl. A shield is or can be interposed between the handle and the bowl to intercept particles of food splashing from the bowl during stir-frying of foodstuffs above a flame.

### BACKGROUND OF THE INVENTION

The present invention relates to improvements in utensils, especially household utensils, and more particularly to improvements in household utensils including those known as woks and analogous cookware which can be utilized for stir-frying meats, fish, vegetables and/or other edible foodstuffs.

A high percentage of the work of a chef in a Chinese restaurant, of a housewife or of one or more persons in another establishment which serves stir-fried foods consists in the manipulation of a wok, heavy with food, over a high flame. Such persons frequently or invariably experience arm and wrist pains after long hours of working, with the wok in hand, to turn out hundreds or even smaller numbers of courses of entrees consisting of or containing stir-fried foodstuffs. The result is a repetitive motion-induced injury known as or similar to the so-called carpal tunnel syndrome. In addition, the hand of a chef who is in charge of manipulating a wok is often burned by droplets of hot oil and/or sauces which are normally admixed to the solid foodstuffs in the bowl of a wok.

As a rule, a conventional stir-fry wok has a substantially hemispherical body or bowl of mild steel and a handle resembling an elongated cylinder and sloping upwardly from the rim of the bowl at an angle of or slightly exceeding 5°. Reference may be had to FIG. 1 of the drawing in the present application which shows a conventional wok 1c having a bowl 2c and a cylindrical handle 3c. The diameter d_{c} of the bowl 2c can be in the range of 14″ (335 mm) and its height h_{c} can be in the range of 4½″ (115 mm). The weight of the wok 1c is or can be in the range of between about 1.2 kg and 1.4 kg. The handle 3c can have a length 1_{c} of between about 7″ and 8″ (180-200 mm) and a diameter di_{c} of between about 1.2″ and 1.5″ (30-38 mm). The angle α_{c} between the axis of the handle 3c and the plane of the rim 4c of the bowl 2c is in the range of 5°.

The manner in which the wok 1c of FIG. 1 is put to use is shown in FIG. 2. As a rule, a chef or another person in charge of utilizing the wok holds the handle 3c with her or his left hand and shakes it quickly back and forth in directions indicated by the double-headed arrow 5c as well as up and down as indicated by the double-headed arrow 6c. This causes a mixing and simultaneous cooking of the contents of the bowl 2c over a flame (not shown). The combined weight of the wok and of the contents of its bowl 2c is or exceeds about 4 lbs, and such weight is being shaken several hundred times per hour during the busy hours of a shift in the kitchen of a restaurant. Due to the customary inclination of the handle 3c relative to the plane of the rim 4c of the bow 2c, the user of the wok 1c employs the weaker position range of her or his hand and arm muscles. This is indicated by the obtuse angle β_{c} between the center lines 7c, 8c of the forearm LA and the hand H of the upper limb UL shown in FIG. 2. When the muscles of the forearm LA and the hand H are to cooperate in an optimal manner, the angle β_{c} should be at least close to 180°, i.e., the center lines 7c, 8c should be at least substantially aligned. This will be fully described hereinafter with reference to FIGS. 8 and 9.

U.S. Pat. No. 4,653,468 (granted Mar. 31, 1987 to Lemme et al. for “COOKWARE HANDLE”) discloses a cooking pan wherein the bowl has a flat bottom part and the handle is indirectly borne by the bowl so that its longitudinal axis makes with the plane of the edge or rim surrounding the open top of the bowl an angle of between 15° and 45° in order “to increase the comfort of the user” (as stated in the Abstract of the patent).

The disclosure of each patent and/or patent application and/or other publication identified in the specification of the present application is incorporated herein by reference.

### OBJECTS OF THE INVENTION

An object of the instant invention is to provide a household utensil, especially a wok, which is constructed, configurated and assembled in such a way that its utilization is less tiresome to taller, shorter, stronger, weaker and/or older persons than the manipulation of conventional utensils of such character.

Another object of the present invention is to provide a household utensil, such as a wok, which is more versatile and more ergonomic than conventional utensils.

A further object of the invention is to provide a novel and improved handle for use with the bowl of a household utensil, particularly a wok or the like.

An additional object of the invention is to provide a wok or an analogous household utensil which can be used with equal advantage by right-handed and by left-handed persons.

Still another object of the invention is to provide a wok wherein the bowl is designed in such a way that a chef, a housewife or another person can evacuate its contents more rapidly and more accurately (such as in a desired direction) than the contents of conventional woks.

A further object of the invention is to provide a wok wherein the selected size, orientation and/or configuration of the handle, as well as the configuration and orientation of the bowl, are such that the hand holding the handle is less likely to come in contact with the escaping contents of the bowl than in conventional woks.

Another object of this invention is to provide a novel and improved connection between the handle and the bowl of the wok.

An additional object of the invention is to provide the above outlined household utensil with a novel and improved bowl.

Still another object of the invention is to provide a wok wherein the bowl is configurated and dimensioned in such a way that its contents can be more readily transferred onto a plate than the contents of the bowl in a conventional wok.

A further object of the invention is to provide a novel and improved method of manipulating a wok prior to and/or during actual use as a household utensil.

Another object of the invention is to provide a novel method of shielding the hand of the person utilizing the improved wok from injury due to the temperature of surrounding air and/or due to the temperature of the contents of the bowl.

### SUMMARY OF THE INVENTION

One feature of the present invention resides in the provision of a utensil for stir-frying foodstuffs. The improved utensil comprises a bowl having a rim, a handle, and means for adjustably connecting the handle to the bowl at the rim.

The connecting means can comprise at least one joint which secures the handle to the bowl for movement about at least one axis between a plurality of different positions. As a rule, the handle is elongated and its longitudinal axis can coincide with the at least one axis. Such connecting means preferably further comprises means for releasably fixing the handle in any one of the plurality of different positions. The longitudinal axis of the handle preferably slopes upwardly toward a plane which contains at least a portion of the rim, at least while the utensil is in use.

The rim of the bowl can be circular or substantially circular (e.g., oval). The at least one joint can be constructed, assembled and mounted to secure the handle to the bowl for pivotal movement about the at least one axis, and such axis is or can be at least substantially tangential to the rim.

At least a portion of the handle can have a non-circular cross-sectional outline, e.g., an ovoid outline. Such outline is particularly desirable if the handle is adjustable about its longitudinal axis because it can be turned to positions in which its manipulation is more convenient to a left-handed or a right-handed person.

In accordance with a presently preferred embodiment of the invention, the connecting means for the handle includes two joints, namely a joint which enables the handle to turn about its longitudinal axis which extends at least substantially radially of the rim of the bowl, and a joint which enables the handle to pivot about a second axis which is normal to the aforementioned longitudinal axis and extends at least substantially tangentially of the rim. Still further, such connecting means can comprise means for releasably fixing the handle in any one of a plurality of different positions relative to the longitudinal axis of the handle and/or relative to the second axis.

In accordance with an additional feature of the invention, the rim of the bowl can have a non-circular (such as an elliptical) outline. This renders it possible to employ a bowl which is considerably lighter than a conventional bowl having a rim with a circular outline.

In accordance with still another feature of the present invention, the improved utensil comprises a shield (e.g., a suitably configurated plate of a heat-resistant material) which is affixed to the bowl and carries or can carry the handle. For example, the shield can be mounted on a support (such as a bracket) which also carries the handle and is affixed to the bowl.

At least a portion of the handle can be made of wood.

The bowl can resemble that of a standard wok, i.e., it can have a convex external surface and a concave internal surface.

Referring again to the aforementioned connecting means, such connecting means can comprise at least one joint including a male component (e.g., an externally threaded bolt) and a female component (e.g., a nut which can mate with the bolt). One of these components is provided on or forms part of the handle, and the other component is provided on and can form part of the bowl. The components have confronting complementary uneven surfaces (e.g., corrugated, toothed or similarly configurated surfaces), and the connecting means further comprises means for releasably urging one of the uneven surfaces against the other uneven surface to thus prevent the handle from moving relative to the bowl when the improved utensil is in actual use.

If the handle is hollow (e.g., if it comprises an elongated tubular handgrip portion), a part of the connecting means can extend through such hollow handle.

Another feature of the invention resides in the provision of a utensil for stir-frying foodstuffs which comprises a bowl, a handle being borne by the bowl, and a shield which is carried by and extends above the bowl. The shield is interposed between the bowl and the handle to intercept particles of foodstuffs being stir-fried in and splattering from the bowl.

A further feature of the invention resides in the provision of a stir-frying utensil which comprises a bowl having a non-circular (e.g., oval or substantially oval) outline, and a handle which is affixed to the bowl.

The novel features which are considered as characteristic of the invention are set forth in particular in the appended claims. The improved utensil itself, however, both as to its construction and the modes of assembling, adjusting and utilizing the same, together with numerous additional important and advantageous features and attributes thereof, will be best understood upon perusal of the following detailed description of certain presently preferred specific embodiments with reference to the accompanying drawing.

### BRIEF DESCRIPTION OF THE DRAWING

FIG. 1 is a somewhat schematic side elevational view of a conventional wok;

FIG. 2 illustrates the structure shown in FIG. 1 and a portion of an upper limb the hand of which grasps the handle of the conventional wok;

FIG. 3 is a fragmentary side elevational view of a wok wherein the handle is configurated, assembled and mounted in accordance with one feature of the present invention;

FIG. 4 is a fragmentary sectional view substantially as seen in the direction of arrows from the line IV-IV in FIG. 3;

FIG. 5 is an end elevational view of the handle of the improved wok, as seen in the direction of arrow V in FIG. 3;

FIG. 6 is a similar end elevational view but showing the handle in a different angular position;

FIG. 7 is a view similar to that of FIGS. 5 or 6 but showing the handle in a third angular position;

FIG. 8 is a fragmentary side elevational view of a handle forming part of a wok wherein such handle is mounted in an orientation other than that shown in FIGS. 1 and 2;

FIG. 9 shows a portion of the arm which is illustrated in FIG. 8 and grasps a novel handle of the improved wok;

FIG. 10 is an end elevational view of a handle having an outline similar to that of the handle shown in FIGS. 5 to 7;

FIG. 11 shows a hand grasping the handle of FIG. 10;

FIG. 12 is a plan view of a wok having a novel bowl; and

FIG. 13 is a side elevational view of the wok shown in FIG. 12.

### DESCRIPTION OF PREFERRED EMBODIMENTS

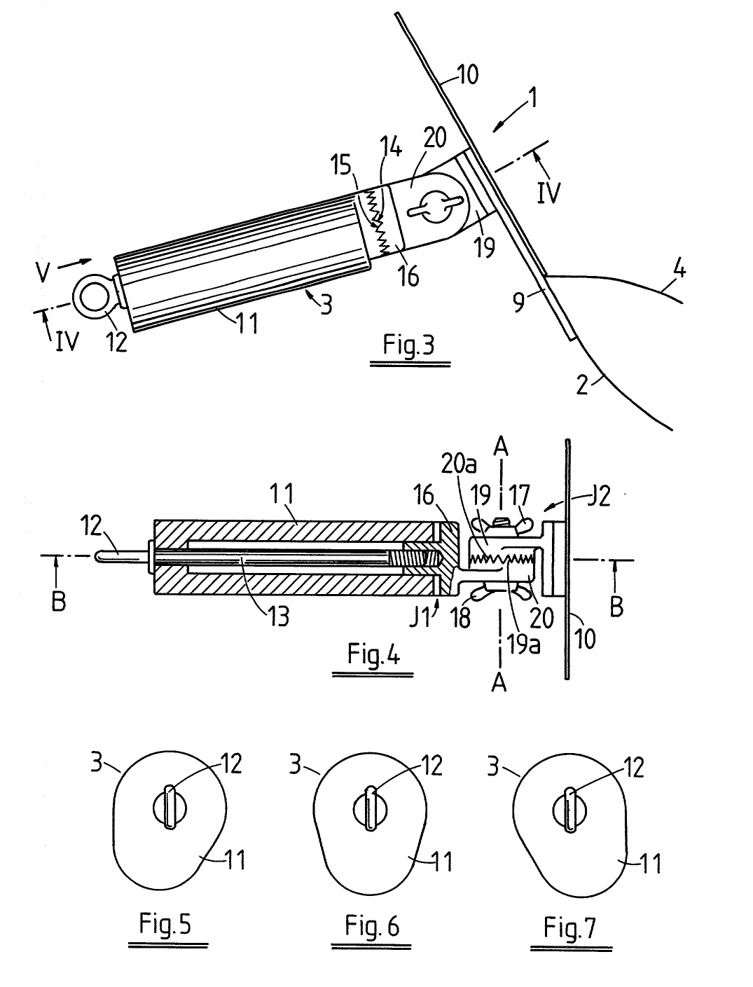

FIGS. 3 and 4 illustrate a portion of a utensil 1 which constitutes a wok and includes a bowl 2, a composite handle 3, a support 9 (such as a bracket) affixed to and extending beyond the edge or rim 4 surrounding the open top of the bowl, and a heat-resistant shield 10 affixed to and extending upwardly beyond the bracket 9. The handle 3 is adjustably secured to the bracket 9 in such a way that it can pivot about an axis A-A which is normal to the longitudinal axis B-B of the elongated tubular handgrip portion 11 of the handle and substantially tangential to the adjacent portion of the rim 4.

In order to change the angular position of the handle 3, the user of the wok 1 turns the eyelet 12 at the outer end of an externally threaded rod-shaped male component or part 13 so that the radially grooved or serrated end face 14 of the handgrip portion 11 can be turned with reference to a complementary serrated or grooved end face 15 on a female component or part 16 of the handle 3. The part 16 can turn about the axis A-A in response to loosening of a wing nut 17 mating with a threaded bolt 18 which defines the axis A-A and normally cooperates with the nut 17 to prevent the handgrip portion 11 from pivoting about such axis.

The wing nut 17 cooperates with the bolt 18 to normally prevent a first locking or fixing member 19 on the bracket 9 from turning relative to a coaxial complementary locking member 20 on the part 16. The locking members 19 and 20 have confronting surfaces 19a, 20a provided with radially extending ribs or teeth which mate when a joint J2 including the parts 17 to 20 is tightened so that the handgrip member 11 is then prevented from pivoting about the axis A-A, i.e., relative to the bowl 2, bracket 9 and shield 10.

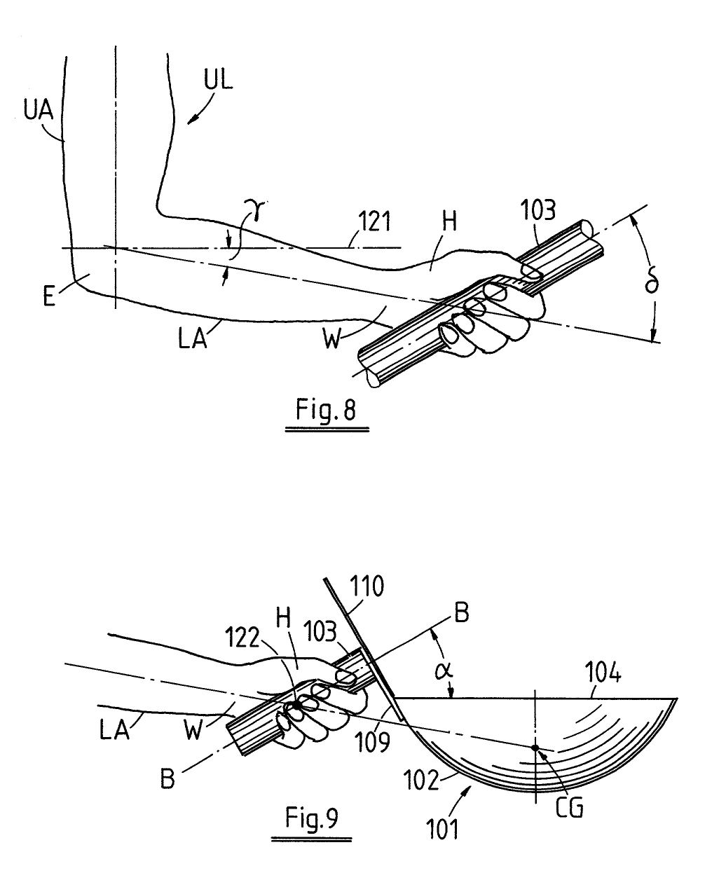

The purpose of the joint J2 including the parts 17, 18 is to permit for angular adjustments of the handgrip portion 11 about the axis A-A, namely to adjust the handle 3 in a manner and for the purposes to be described with reference to FIGS. 8 and 9. The purpose of a joint J1 including the parts 13, 16 is to permit for changes in the angular position of the handgrip portion 11 about its longitudinal axis B-B, e.g., for the purposes to be described with reference to FIGS. 5, 6 and 7.

The joints J1 and J2 form part of a means for adjustably connecting the handle 3 to the bowl 2 at the edge or rim 4. The uneven complementary surfaces 14, 15 of the joint J1 (i.e., of the connecting means) serve as a means for releasably fixing the handgrip portion 11 of the handle 3 in any one of a plurality of different angular positions with reference to the axis B-B, and the uneven complementary surfaces 19a, 20a of the joint J2 (i.e., of the connecting means) serve as a means for releasably fixing the handle 3 in any one of several positions of inclination relative to the rim 4 of the bowl 2, i.e., with reference to the axis A-A.

The uneven surface 14 is provided on the handle 3, and the uneven surface 15 is provided on the part 16 which is carried by the bowl 2. Analogously, the uneven surface 20a can be said to be (indirectly) carried by the handle 3, and the surface 19a is carried by the bowl 2.

In order to change the angular position of the handgrip portion 11 of the handle 3 about the axis B-B of the rod 13, the eyelet 12 (or an equivalent part) is turned by hand or by resorting to a suitable tool (such as pliers, a pin inserted into the eyelet or in another suitable manner) and the rod 13 is rotated to the extent which is necessary to permit turning of the uneven surface or end face 14 relative to the adjacent complementary uneven surface 15 of the part 16. The handgrip portion 11 can be turned about its axis B-B to any one of a practically infinite number of different positions including those shown in FIGS. 5, 6 and 7.

FIG. 5 shows that angular position of the handgrip portion 11 which is best suited for a left-handed user, FIG. 6 shows the handgrip portion 11 in a neutral position, and FIG. 7 shows the handgrip portion 11 in an angular position best suited for a right-handed user. The handgrip portion 11 has an ovoid cross-sectional outline.

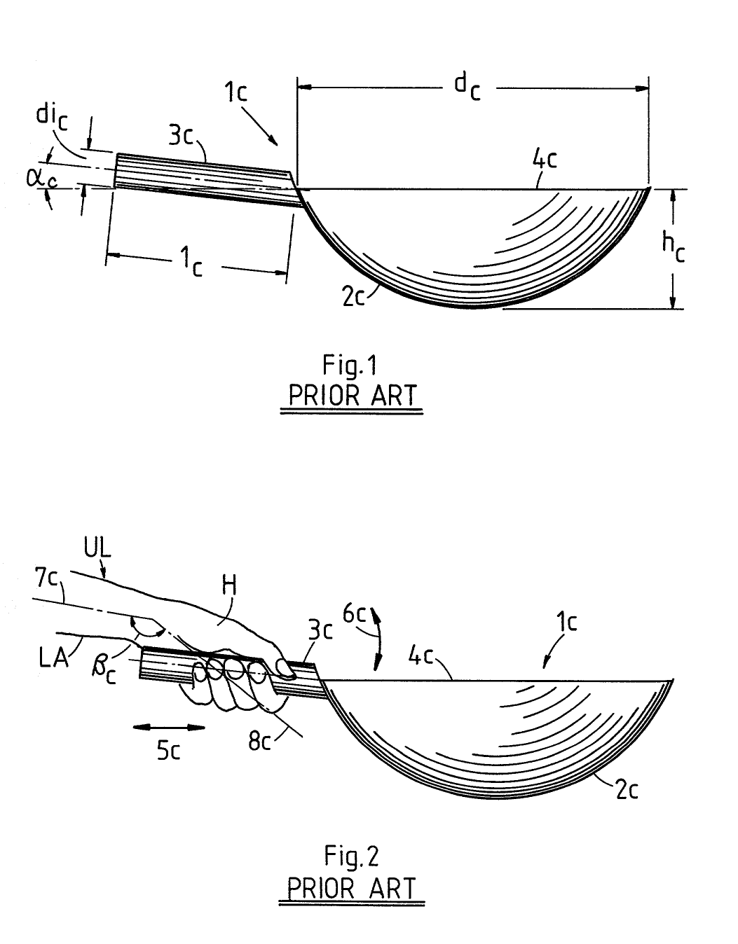

Referring to FIG. 8, there is shown a handle 103 the inclination of which relative to the edge or rim 104 surrounding the open top of a standard bowl 102 (see FIG. 9) is approximately 30° (note the angle α shown in FIG. 9). This brings about the advantage that the upper arm UA of the upper limb UL shown in FIG. 8 is substantially vertical, that the forearm or lower arm LA slopes relative to a horizontal plane 121 at an angle γ of approximately 10°, and that the axis of the hand H which grips the handle 103 coincides with the axis of the forearm LA. The angle δ between the common axis of the hand H and forearm LA on the one hand and the plane of the rim 104 on the other hand is approximately 40°; the handle 103 slopes upwardly toward and even beyond the rim 104 of the bowl 102 (the same as in FIG. 3) in contrast to the handle 3c of FIGS. 1 and 2 which slopes downwardly toward the rim 4c of the bowl 2c. The novel mounting of the handle 103 (e.g., in a manner as already described with reference to FIGS. 3 and 4) enables the user of the wok 101 including the bowl 102 of FIG. 9 to select an optimum angle δ which is best suited to ensure that the axis of the upper arm UA is vertical and that the axis of the forearm LA at least substantially coincides with the axis of the hand H shown in FIG. 8 when the wok 101 of FIG. 9 is ready for use or in actual use.

It has been found that the anatomy of a human arm UL, its wrist W and its hand H is such that the optimal (strongest) position range to hold an elongated cylindrical or substantially cylindrical wok handle is that shown in FIG. 8. As already mentioned hereinbefore, the angle γ between the horizontal plane 121 including the pivot axis defined by the elbow E and the common axis of the forearm LA and the hand H is approximately 10°. Such inclination of the handle 103 relative to the plane of the rim 104 renders the wok 101 ergonomic (i.e., best suited to ensure that the wok and the upper limb UL shown in FIG. 8 will interact in a most effective and safe manner.

FIG. 9 further shows a bracket or support 109 and a shield 110 which latter carries the handle 103 jointly with or independently of the bracket. The handle 103 can be riveted, welded or otherwise secured to the part 109 and/or 110. The same applies for the connection between the shield 110 and the bracket 109 and for the connection between the bracket and the body of the bowl 102. The handle 103 can be adjustably affixed to the bowl 102, e.g., by resorting to connecting means of the type shown in FIGS. 3 and 4 or to analogous or equivalent connecting means. However, it is equally within the purview of the invention to adjustably install the handle 103 in such a way that it is only pivotable about the axis A-A or only about the axis B-B (both shown in FIG. 4).

In order to maximize muscle control with a minimal effort for the purpose of turning the bowl 102 sideways in order to pour the stir-fried contents onto a plate or the like, the center of gravity CG of the wok 101 should be located on an extension of the common center line of the forearm LA and the hand H. As a rule, it is advisable to mount the handle 103 as close to the bowl 102 as possible; this reduces the momentum upon the hand H, the wrist W and the elbow E when the wok 101 is in actual use. The intersection point between the axis B-B of the handle 103 and the common axis of the forearm LA and the hand H should be located at or close to the median portion 122 of the axis B-B, i.e., midway between the ends of the handle 103.

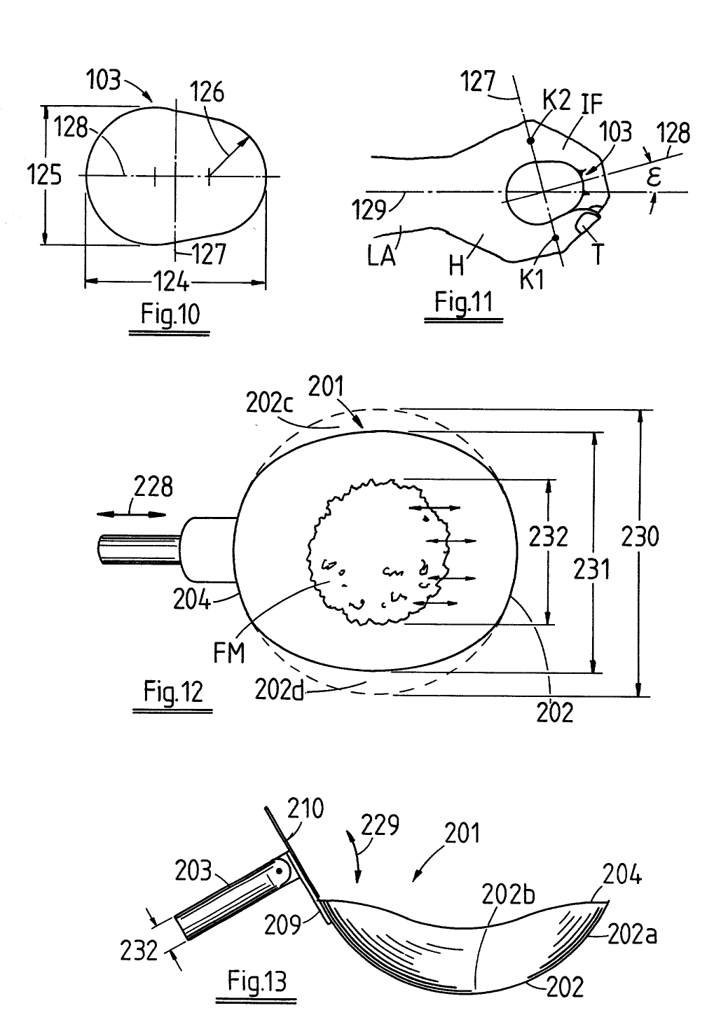

The advantages of a handle 103 having an ovoid outline of the type shown in FIGS. 5 to 7 will be described with reference to FIGS. 10 and 11. The optimal dimensions of the ovoid cross-section of the handle 103 shown in FIGS. 10 and 11 can be selected in dependency upon the size of the hand H. However, in many or most instances, and assuming that the handle 103 is to be utilized by a chef having a medium sized hand H, the major axis 124 of the substantially ovoid cross-sectional outline of the handle 103 is approximately 1¾″ (45 mm), the minor axis 125 is approximately 1⅜″ (35 mm), and the radius 126 is approximately 9/16″ (14 mm).

The maximum clamping force is normally applied by that portion of the hand H which is located between the knuckle K1 of the thumb T and the knuckle K2 of the index finger IF. The line 127 which connects the knuckles K1 and K2 can be said to constitute the transverse center line of the ovoid outline of the handle 103. The longitudinal centerline 128 of the ovoid outline of the handle 103 makes with the centerline 129 of the forearm LA an angle ε of approximately 15 degrees. The centerline 129 of the forearm LA coincides with that of the hand H. Because of the angle ε, the mounting of the handle 103 will have a mirror image for a righthanded user of wok 101.

An advantage of the ovoid cross-sectional outlines of the handles 3 and 103 is that such handles can be reliably gripped in a kitchen by one hand, H, even if the hand H and/or the handle 3 or 103 is greasy or is slippery for any other reason. The anatomy of the hand should be considered to provide a maximum surface-to-surface contact between the hand and the peripheral surface of the handle 3 or 103 as well as to ensure a positive grip and the generation of a uniformly distributed pressure. The handle 3 or 103 should fit snugly into the polygonal space defined by the thumb T and the index finger IF shown in FIG. 11. These fingers define a tunnel having an internal surface complementary to the external surface of a handle having an ovoid outline as shown in FIGS. 10 and 11.

It has been ascertained that a handle 3 or 103 having a length of about 6″ (150 mm) is quite satisfactory. This handle can be made of a lighweight material (a presently preferred material is wood) having satisfactory heat insulating properties. The external surface of the handle 3 or 103 is or can be textured.

Another feature of the present invention resides in the provision of a wok 201 (see FIGS. 12 and 13) having a non-circular outline. Such outline is preferably obtained by removing some material from the two lateral sides (as at 202c and 202d) of the bowl 202 so that the rim 204 of the bowl 202 is not located in a single plane (see FIG. 13). As already explained with reference to FIGS. 1 and 2, a presently popular conventional wok 1c can employ a bowl 2c having a diameter in the range of 14″ (355 mm) and a depth of about 4½″ (115 mm). The contour of my bowl can vary, depending upon the manufacturer but, as a rule, it is always bounded by a convex external surface 202a and a complementary concave internal surface 202b.

When the wok (such as the wok 201 shown in FIGS. 12 and 13) is in use, it is shaken in directions indicated by the double-headed arrow 228, as well as up and down (as indicated by the double-headed arrow 229). The foodstuff or food mass FM in the bowl 202 invariably moves back and forth (arrow 228) at the center of the concave upper side or surface 202b, normally through a distance of between 7″ and 9″ (180 and 230 mm). In view of such mode of utilizing the wok 201, the fact that the sides of the bowl 202 are partially removed at 202c and 202d does not affect the utility of such wok. On the other hand, removal of material of the bowl 202 at 202c, 202d brings about a pronounced reduction of the weight of the wok 201. The removal of material at 202c, 202d entails a reduction of the width of the bowl 202 from the value 230 to that shown at 231. The customary width of the material (foodstuff) FM in the bowl 202 is shown at 232. Another advantage of a wok 201 employing a bowl 202 of the type shown in FIGS. 12 and 13 is that it allows for a reduction of the angle through which the wok 201 must be tilted by turning it clockwise or counterclockwise about the longitudinal axis of the handle 203 in order to transfer the contents of the bowl 202 onto a plate or the like. This will be readily appreciated by looking at FIG. 13 which shows that the level of the rim 204 is higher at the three and nine o'clock positions (as viewed in FIG. 12) than at the six and twelve o'clock positions.

The shield 210 is made of a heat-resistant material and does not carry the adjacent end portion of the handle 203; such end portion is affixed to bracket or support 209 at a level above the nearest portion of the rim 204. The width of the shield 210 can but need not always approximate or match three times the diameter of the handle 203.

The improved utensil is susceptible of numerous additional modifications without departing from the spirit of the present invention. For example, the joint J1 of FIGS. 3 and 4 can be utilized with or in lieu of the joint J2, the joint J1 and/or J2 can be utilized to adjustably connect the handle to a bowl having a circular or an oval rim, the shield can be utilized on a bowl which carries the joint J1 and/or J2 or the equivalent(s) thereof, the joint J1 and/or J2 can be omitted and the improved utensil then employs a bowl having a non-circular outline and/or a shield, and so forth.

Without further analysis, the foregoing will so fully reveal the gist of the present invention that others can, by applying current knowledge, readily adapt it for various applications without omitting features that, from the standpoint of prior art, fairly constitute essential characteristics of the generic and specific aspects of the above outlined contribution to the art of household utensils and, therefore, such adaptations should and are intended to be comprehended within the meaning and range of equivalence of the appended claims.

What is claimed is:

1. A utensil for stir-frying foodstuffs, comprising:
a bowl having a rim;
a handle; and
means for adjustably connecting said handle to the bowl at said rim.

2. The utensil of claim 1, wherein said connecting means comprises at least one joint securing said handle to said bowl for movement about at least one axis between a plurality of different positions.

3. The utensil of claim 2, wherein said handle is elongated and has a longitudinal axis coinciding with said at least one axis, said connecting means further comprising means for releasably fixing said handle in any one of said plurality of different positions.

4. The utensil of claim 3, wherein at least a portion of said rim is disposed in a predetermined plane and said longitudinal axis slopes upwardly toward said plane.

5. The utensil of claim 2, wherein said rim is at least partially circular and said at least one joint secures said handle to said bowl for pivotal movement about said at least one axis, said at least one axis being at least substantially tangential to said rim.

6. The utensil of claim 2, wherein at least a portion of said handle has a non-circular cross-sectional outline.

7. The utensil of claim 6, wherein said cross-sectional outline is a substantially ovoid outline.

8. The utensil of claim 2, wherein said rim is at least partially circular and said handle is elongated and has a longitudinal axis coinciding with said at least one axis, said connecting means further comprising means for releasably fixing said handle in any one of said plurality of different positions, a second joint securing said handle to said bowl for pivotal movement between a plurality of different positions about a second axis at least substantially normal to said at least one axis, and means for releasably fixing said handle in any one of said plurality of different positions relative to said second axis.

9. The utensil of claim 1, wherein said rim has a non-circular outline.

10. The utensil of claim 9, wherein said outline is a substantially elliptical outline.

11. The utensil of claim 1, further comprising a shield borne by said bowl, extending above said rim and disposed between said rim and said handle to intercept particles of foodstuffs being stir-fried in and splattering from said bowl.

12. The utensil of claim 11, further comprising a support affixed to said bowl and carrying said shield, said handle and said connecting means.

13. The utensil of claim 11, wherein said shield includes a plate of a heat-resistant material.

14. The utensil of claim 1, wherein at least a portion of said handle consists of wood.

15. The utensil of claim 1, wherein said bowl has a convex external surface and a concave internal surface

16. The utensil of claim 1, wherein said connecting means comprises at least one joint including a male component and a female component, one of said components being borne by said handle and the other of said components being borne by said bowl, said components having confronting complementary uneven surfaces and said connecting means further comprising means for releasably urging one of said uneven surfaces against the other of said uneven surfaces to thus prevent said handle from moving relative to said bowl.

17. The utensil of claim 16, wherein said means for releasably urging comprises a tapped nut and an externally threaded bolt mating with said nut.

18. The utensil of claim 1, wherein said handle is hollow and said connecting means includes a part extending through said hollow handle.

19. A utensil for stir-frying foodstuffs, comprising:
a bowl;
a handle borne by said bowl; and
a shield carried by and extending above said bowl, said shield being interposed between said bowl and said handle to intercept particles of foodstuffs being stir-fried in and splattering from said bowl.

20. A utensil for stir-frying foodstuffs, comprising:
a bowl having a non-circular outline; and
a handle borne by said bowl.
